(19) United States
(12) Patent Application Publication
(10) Pub. No.: US 2025/0322206 A1
(43) Pub. Date: Oct. 16, 2025

(54) GRAPH-BASED MODELING OF RELATIONAL AFFECT IN GROUP INTERACTIONS

(71) Applicant: Honda Motor Co., Ltd., Tokyo (JP)

(72) Inventors: Weinan WANG, Piscataway, NJ (US); Hifza JAVED, Fremont, CA (US); Affan Bin USMAN, Santa Clara, CA (US); Nawid JAMALI, San Francisco, CA (US)

(21) Appl. No.: 18/818,266

(22) Filed: Aug. 28, 2024

Related U.S. Application Data
(60) Provisional application No. 63/633,311, filed on Apr. 12, 2024.

(51) Int. Cl. G06N 3/042

(52) U.S. Cl. CPC G06N 3/042

(57) ABSTRACT

According to one aspect, graph-based modeling of relational affect in group interactions may include generating a graph neural network (GNN) based on multi-modal behavioral data associated with interactions between two or more individuals for each of the two or more individuals and relational context information associated with the interaction or the two or more individuals, performing message passing between nodes of the GNN based on the relational context information, generating a representation read-out associated with the GNN or a subgraph of the GNN, and performing an action based on the representation read-out.

### CROSS-REFERENCE TO RELATED APPLICATIONS

This application claims the benefit of U.S. Provisional Patent Application, Ser. No. 63/633,311 (Attorney Docket No. H1240993US01) entitled “SYSTEMS AND METHODS FOR DYNAMIC-GRAPH-BASED MODELING OF MULTI-PERSPECTIVE RELATIONAL AFFECT IN GROUP INTERACTIONS”, filed on Apr. 12, 2024; the entirety of the above-noted application(s) is incorporated by reference herein.

### BACKGROUND

With the tremendous success of deep networks in image and language applications, predicting human behaviors has become a focus of attention in many other areas, including science. Deep networks have shown success in performing a variety of tasks with human-like and even super-human accuracy, leading to outperforming humans in some tasks. However, many scientific questions are focused on modelling and analyzing data, and thus, strive for explanations rather than performing predictions. In contrast to prediction tasks, it may not be self-obvious how deep networks may help understand a natural process, such as a group interaction between individuals of a group, for example.

### BRIEF DESCRIPTION

According to one aspect, a computer-implemented method for graph-based modeling of relational affect in group interactions may include generating a graph neural network (GNN) based on multi-modal behavioral data associated with interactions between two or more individuals for each of the two or more individuals and relational context information associated with the interaction or the two or more individuals, performing message passing between nodes of the GNN based on the relational context information, generating a representation read-out associated with the GNN or a subgraph of the GNN, and performing an action based on the

According to one aspect, a system for graph-based modeling of relational affect in group interactions may include a processor and a memory. The memory may store one or more instructions. The processor may execute one or more of the instructions stored on the memory to perform one or more acts, actions, and/or steps, such as generating a graph neural network (GNN) based on multi-modal behavioral data associated with interactions between two or more individuals for each of the two or more individuals and relational context information associated with the interaction or the two or more individuals, edges of the GNN may be associated with weights based on the relational context information, performing message passing between nodes of the GNN based on the weights of respective edges, and generating a representation read-out associated with the GNN or a subgraph of the GNN.

According to one aspect, a robot for mediating group interactions based on graph-based modeling of relational affect of the group interactions may include a memory and a processor. The memory may store one or more instructions. The processor may execute one or more of the instructions stored on the memory to perform one or more acts, actions, and/or steps, such as generating a graph neural network (GNN) based on multi-modal behavioral data associated with interactions between two or more individuals for each of the two or more individuals and relational context information associated with the interaction or the two or more individuals, wherein edges of the GNN are associated with weights based on the relational context information, performing message passing between nodes of the GNN based on the weights of respective edges, and generating a representation read-out associated with the GNN or a subgraph of the GNN. The robot may include an output device performing a social mediation action based on the representation read-out.

### BRIEF DESCRIPTION OF THE DRAWINGS

FIG. 1 is an exemplary computer-implemented method for graph-based modeling of relational affect in group interactions, according to one aspect.

FIG. 2 is an exemplary system for graph-based modeling of relational affect in group interactions, according to one aspect.

FIG. 3A-3D are exemplary implementations in relation to the computer-implemented method and the system for graph-based modeling of relational affect in group interactions of FIGS. 1-2, according to one aspect.

FIG. 4 is an illustration of an example computer-readable medium or computer-readable device including processor-executable instructions configured to embody one or more of the provisions set forth herein, according to one aspect.

FIG. 5 is an illustration of an example computing environment where one or more of the provisions set forth herein are implemented, according to one aspect.

### DETAILED DESCRIPTION

The following includes definitions of selected terms employed herein. The definitions include various examples and/or forms of components that fall within the scope of a term and that may be used for implementation. The examples are not intended to be limiting. Further, one having ordinary skill in the art will appreciate that the components discussed herein, may be combined, omitted, or organized with other components or organized into different architectures.

A “processor”, as used herein, processes signals and performs general computing and arithmetic functions. Signals processed by the processor may include digital signals, data signals, computer instructions, processor instructions, messages, a bit, a bit stream, or other means that may be received, transmitted, and/or detected. Generally, the processor may be a variety of various processors including multiple single and multicore processors and co-processors and other multiple single and multicore processor and co-processor architectures. The processor may include various modules to execute various functions.

A “memory”, as used herein, may include volatile memory and/or non-volatile memory. Non-volatile memory may include, for example, ROM (read only memory), PROM (programmable read only memory), EPROM (erasable PROM), and EEPROM (electrically erasable PROM). Volatile memory may include, for example, RAM (random access memory), synchronous RAM (SRAM), dynamic RAM (DRAM), synchronous DRAM (SDRAM), double data rate SDRAM (DDRSDRAM), and direct RAM bus RAM (DRRAM). The memory may store an operating system that controls or allocates resources of a computing device.

A “disk” or “drive”, as used herein, may be a magnetic disk drive, a solid-state disk drive, a floppy disk drive, a tape drive, a Zip drive, a flash memory card, and/or a memory stick. Furthermore, the disk may be a CD-ROM (compact disk ROM), a CD recordable drive (CD-R drive), a CD rewritable drive (CD-RW drive), and/or a digital video ROM drive (DVD-ROM). The disk may store an operating system that controls or allocates resources of a computing device.

A “bus”, as used herein, refers to an interconnected architecture that is operably connected to other computer components inside a computer or between computers. The bus may transfer data between the computer components. The bus may be a memory bus, a memory controller, a peripheral bus, an external bus, a crossbar switch, and/or a local bus, among others. The bus may also be a vehicle bus that interconnects components inside a vehicle using protocols such as Media Oriented Systems Transport (MOST), Controller Area network (CAN), Local Interconnect Network (LIN), among others.

A “database”, as used herein, may refer to a table, a set of tables, and a set of data stores (e.g., disks) and/or methods for accessing and/or manipulating those data stores.

An “operable connection”, or a connection by which entities are “operably connected”, is one in which signals, physical communications, and/or logical communications may be sent and/or received. An operable connection may include a wireless interface, a physical interface, a data interface, and/or an electrical interface.

A “computer communication”, as used herein, refers to a communication between two or more computing devices (e.g., computer, personal digital assistant, cellular telephone, network device) and may be, for example, a network transfer, a file transfer, an applet transfer, an email, a hypertext transfer protocol (HTTP) transfer, and so on. A computer communication may occur across, for example, a wireless system (e.g., IEEE 802.11), an Ethernet system (e.g., IEEE 802.3), a token ring system (e.g., IEEE 802.5), a local area network (LAN), a wide area network (WAN), a point-to-point system, a circuit switching system, a packet switching system, among others.

An “emotion”, as used herein, refers to a conscious mental reaction subjectively experienced as strong feeling usually directed toward a specific object and typically accompanied by physiological and behavioral changes in the body.

A “mood”, as used herein, refers to a transient, low-intensity, nonspecific, and subtle affective state that often has no definite cause.

An “affect”, as used herein, refers to a collective term for describing feeling states, such as emotions and moods.

A “group affect”, as used herein, refers to a collective-level affect, representative of a group as a collection of individuals.

A “relational affect”, as used herein, refers to a dyadic construct between an individual and other interactant individual(s) in a group that captures the interpersonal dynamics of an interaction among interactants in the group.

A “relational context”, as used herein, refers to a set of circumstances, environments, and surroundings that describes a nature of an existing relationship between a person and his or her interaction partner.

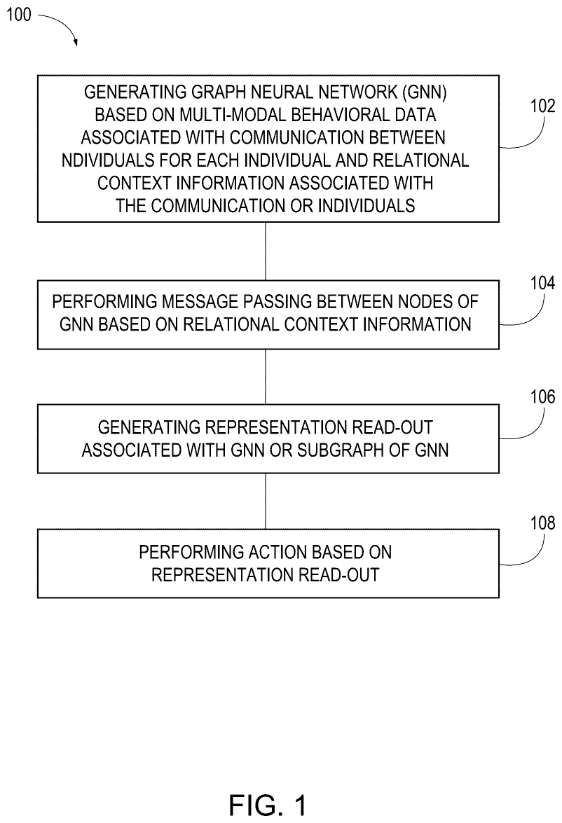

FIG. 1 is an exemplary computer-implemented method 100 for graph-based modeling of relational affect in group interactions, according to one aspect. The computer-implemented method 100 for graph-based modeling of relational affect in group interactions may include generating 102 a graph neural network (GNN) based on multi-modal behavioral data associated with interactions between two or more individuals for each of the two or more individuals and relational context information associated with the interaction or the two or more individuals, performing 104 message passing between nodes of the GNN based on the relational context information, generating 106 a representation read-out associated with the GNN or a subgraph of the GNN, and performing 108 an action based on the representation read-out. In this way, the computer-implemented method 100 for graph-based modeling of relational affect in group interactions may consider a modulation effect of relational context on human interaction, which alters the perception and experience of relational affect within a group including the two or more individuals.

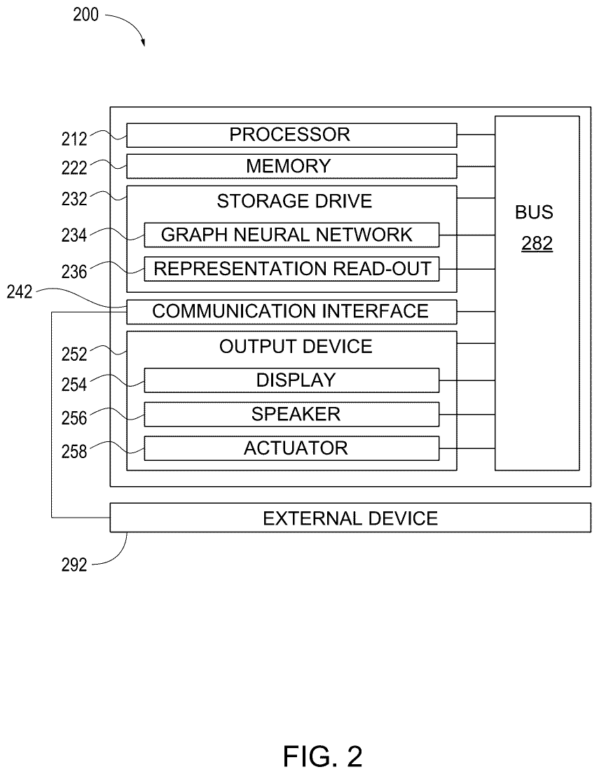

FIG. 2 is an exemplary system 200 for graph-based modeling of relational affect in group interactions, according to one aspect. The system 200 for graph-based modeling of relational affect in group interactions may be a robot for mediating group interactions based on graph-based modeling of relational affect of the group interactions, for example. According to one aspect, the system 200 for graph-based modeling of relational affect in group interactions may include a processor 212, a memory 222, and a storage drive 232. The storage drive 232 may store a graph neural network (GNN) 234 and one or more representation read-outs 236 generated by the processor 212 or received from another device. The system 200 for graph-based modeling of relational affect in group interactions may include a communication interface 242 and an output device 252. The output device 252 may include a display 254, a speaker 256, and/or an actuator 258. A bus 282 may communicatively couple respective components (e.g., the processor 212, the memory 222, the storage drive 232, the communication interface 242, etc.) of the system 200 for graph-based modeling of relational affect in group interactions.

Although the processor 212 is described as generating the GNN 234 herein, it will be appreciated that the GNN 234 may be generated from another device and transmitted to the system 200 for graph-based modeling of relational affect in group interactions. For example, the communication interface 242 may receive the GNN 234 from an external device 292 and thus, the GNN 234 may be generated external to the system 200 for graph-based modeling of relational affect in group interactions. Additionally, the communication interface 242 may receive multi-modal behavioral data and pass this along to the processor 212 via the bus 282, as described herein.

The memory 222 may store one or more instructions. The processor 212 may execute one or more of the instructions stored on the memory 222 to perform one or more acts, actions, and/or steps.

The processor 212 may receive multi-modal behavioral data associated with interactions (e.g., which may include verbal communication, non-verbal communication, etc.) between two or more individuals for each of the two or more individuals. For example, the processor 212 may receive multi-modal behavioral data associated with a first individual of the two or more individuals, multi-modal behavioral data associated with a second individual of the two or more individuals, multi-modal behavioral data associated with a third individual of the two or more individuals, etc. The multi-modal behavioral data may include eye-tracking data, image data (e.g., facial expressions), video data, audio data (e.g., tone), communications exchanged between interactants, such as text messages, instant messages, emails, online chat, Short Message Service (SMS), etc.

The processor 212 may receive relational context information associated with the interaction and/or the two or more individuals. The relational context information may include a native language associated with an individual of the two or more individuals, an educational level associated with the individual, a position of the individual, a background of the individual, lines of vision between individuals, language used by individual, demographic information, a historical social connection, or other information indicative of the intensity of communication.

### Graph Neural Network (GNN)

According to one aspect, an input for the system 200 for graph-based modeling of relational affect in group interactions may be the multi-modal behavioral data collected from each individual during a group interaction, as well as the relational context information. Using these inputs, the processor 212 may generate the GNN 234 based on multi-modal behavioral data associated with interactions between two or more individuals for each of the two or more individuals and relational context information associated with the interaction or the two or more individuals. The storage drive 232 may store the GNN 234 and one or more representation read-outs 236 generated by the processor 212.

For each individual, data from different modalities may be represented as nodes. These nodes may be connected together to form an individual-level graph representation (e.g., subgraph) of each individual. Specifically, nodes corresponding to different data modalities recorded from the same individual may be linked together using edges. This connectivity enables intrapersonal message passing, discussed herein, synthesizing high-level behavioral information. The resulting GNN captures both verbal and non-verbal interactions, as well as responses across heterogeneous communication modalities, which may be important clues of human's affective status, such as emotion, valance, arousal, and involvement in interactions.

### Group-Level Graph Based on Relational Context

The processor 212 may construct the GNN 234 to include group-level graphs from which multi-scale information related to the group, interpersonal, and individual-level interactions may be derived. The processor 212 may fuse and extract representations related to relational affect associated with the individuals of the group. Explained another way, the processor 212 may create group-level representations of human behavior using a directed and weighted graph for the GNN 234. This enables the processor 212 to model the dynamics of multi-party human or individual interactions during group activities, considering relational context of communication between different individuals.

Relational context may be the set of circumstances, environments, and surroundings that describe the nature of an existing relationship between an individual and his or her corresponding interaction partner. Relational context encompasses various factors, including the individual differences, the type of relationship, and the developmental stages of the interaction, that shapes and modulates the interaction between people in terms of the way they perceive, communicate, and behave towards each other. Therefore, relational context describes the intention and willingness of an individual to communicate with another individual, which decides the extent that one individual's affective status may be affected by the affective status of another individual.

In this way, the processor 212 may generate the GNN 234 to consider the effects of relational context to form directed and weighted edges between individual-level graphs created, to form a group-level graph representation of the group interaction that embeds the likelihood that one individual may be affected by the affective status of another individual in the group at a certain stage of interaction. The directions and weights of these interpersonal edges may be learned by the processor 212 using deep learning models, or decided using heuristic, rule-based decision methods, based on the relational context information recorded during the interaction, for example.

Therefore, the processor 212 may consider effects of relational context on the exchange of information during the group interaction and embed this information within the connections in the created group-level graphs of the GNN 234, to facilitate efficient learning from the human multi-modal behavioral data. For example, edges of the GNN 234 may be associated with weights based on the relational context information. In this regard, the processor 212 may perform message passing between the nodes of the GNN 234 based on the weights associated with the respective edges. Therefore, the advantage of capturing an individual relation affect that is influenced and connected to behaviors of other human interactants is provided. Weights may be updated over time, thereby changing the dynamic of the GNN 234.

The following examples show how the direction and intensity of interpersonal connection may be related to the relational context that changes the communication pattern between individuals within a group.

According to a first example, for an audio-video-demographic dataset recorded during group interaction in an ice-breaking scenario, group-level graphs may be created by connecting individual-level graphs from individuals who speak the same native language with bidirectional, heavily weighted edges, since they exchange more information with each other due to lower language barriers.

According to a second example, for an audio-video dataset that records continuous group discussion in a group of three individuals (e.g., individual A, B, C), relational context information may be extracted from the audio clips that identify who is talking to who. From this information, those group-level graphs created from time frames in which individuals A and B are actively talking to each other while individual C is listening, will have bi-directional, heavily weighted edges between subgraphs representing individual A and B. Meanwhile, individual C is only connected to individual A and B with single-directional, lightly weighted edges. As such, the group-level graph describes a relational context that individuals A and B are more involved in intensively exchanging information, thus having personal relational affect being more dependent on each other.

According to a third example, for an audio-transcript dataset recorded in a lecture giving scenario, the audio transcript may be used as relational context information to identify the content of communication. When the teacher is instructing the students, the group-level graphs may be created by highlighting single-directional teacher-student connections. On the contrary, when the students are discussing a topic assigned by the teacher, the group-level graph weights low on teacher-student connections, while the group-level graph weights high on student-student connections.

### Message Passing

The processor 212 may employ message passing to capture relational affect at multiple levels, such as between individuals to capture the relational affect between two specific individuals, between an individual and other individuals (e.g., one-to-a-subgroup), thereby encompassing the relational affect between an individual and a sub-group, or a group level interaction affect capturing the overall affect within the entire group. The sub-group may include scenarios involving one individual and the rest of the group.

Using the GNN 234, weighted message passing may be conducted iteratively for certain rounds between nodes connected in the group-level graph, and node embeddings fusing multi-modal and multi-individual information may be learned. This models the multi-modal communication that takes place during the inter-individual interaction in the group activity, which manifests as changes in individual's relational status due to interactive inputs and outputs from and to other individuals.

### Message Passing—Individual Message Passing

Individual-level message passing between nodes in the individual-level graphs depicts the inner and personal activity of each individual during the interaction, which may be understood by the GNN 234 by exchanging information across modalities. For example, the processor 212 may perform the message passing between the nodes of the GNN 234 using individual message passing between a first node of a first individual-level subgraph associated with a first individual of the two or more individuals and a second node of the first individual-level subgraph.

### Message Passing—Interpersonal Message Passing

Message passing may also be conducted within subgraphs that include the intrapersonal and interpersonal edges that describe the interaction of a subgroup of individuals, such as individuals of a dyadic interaction. In this case, the GNN 234 may learn affect information of an individual toward another individual, such as the individual's impression or affective rating toward his or her partner. For example, the processor 212 may perform the message passing between the nodes of the GNN 234 using interpersonal message passing between a first node of a first individual-level subgraph associated with a first individual of the two or more individuals and a first node of a second individual-level subgraph associated with a second individual of the two or more individuals.

### Message Passing—Group Messge Passing

Message passing may be conducted over the entire group-level graph to model the group interaction. Such message passing includes inter-individual communication through interpersonal edges formed between all individuals in the group. The relational context information embedded in the direction and intensity of interpersonal edges pose restrictions on the interpersonal message passing, to align the direction and intensity of different communications that take place during the group interaction with the reality.

### Representation Read-Out

From the node embeddings learned through the GNN 234 with rich affective information, readout operations may be implemented to aggregate affective information from different observation perspectives of the group interaction. For different downstream tasks that requires individual, interpersonal, or group-level affect information, the readout operation may be carried out on nodes in different subgraphs of the group-level graph, by adding, averaging, concatenating, or learning from the node embeddings from all nodes involved in the subgraph.

In this regard, the processor 212 may generate a representation read-out 236 associated with the GNN 234 or a subgraph of the GNN 234. According to one aspect, the representation read-out 236 associated with the subgraph of the GNN 234 may be a representation read-out 236 indicative of relational affect associated with one or more of the two or more individuals. According to one aspect, the representation read-out 236 associated with the GNN 234 may be a representation read-out indicative of relational affect associated with the two or more individuals.

### Downstream Actions or Tasks

The advantages of representing multi-model and multi-party information in flexible scales and contexts of group interaction makes the affective representations learned from the created graph useful in multiple downstream actions. According to one aspect, the processor 212 may perform an action based on the representation read-out 236. For example, the action may be a social networking action or a reformulation of the GNN 234.

According to one aspect, the processor 212 may cause a social networking application to reveal implicitly similarity between people in a group, by reading-out the individual-level affect from individual subgraphs in the group-level graph, and reveals those people who had similar affect experiences without having a highly weighted social connection, since they may have shared but implicit characteristics that results to similar experiences in their own circle of social connection. With such information, the system may generate matchmaking recommendations to expand their social networks.

A researcher may combine multi-modal data collected during human interaction experiences with manually annotated interpersonal connections, to validate the modality and type of collected data with respect to their correspondence and importance for affect estimation. For example, if the collected data fits poorly to the collected affect ratings when used on a graph structure that precisely describes the interpersonal interactions, the processor 212 may indicate that the collected information has little correspondences with the affect ratings.

According to another aspect, the output device 252 may perform the action based on the representation read-out 236. For example, the action may be a social mediation action implemented by the robot for mediating group interactions based on graph-based modeling of relational affect of the group interactions. The robot may render a message on the display 254, play an audio message via the speaker 256, or move according to the actuator 258, for example.

The social mediation may mediate group interactions at different levels of granularity using the learned node embeddings in the graph. The processor 212 may compute the affect of a specific individual involved in the interaction by aggregating node embeddings corresponding to that individual, and directionally encourage him to participate in the group activity. The processor 212 may also estimate an overall, group-level affect, such as group cohesion, from all node embeddings in the group-level graph, and express appreciation to the high level of cooperation during the group activity. Furthermore, by fusing information from both group-level and individual-level nodes, the processor 212 may even give directed, individual-specific instructions in the form of undirected instructions, to reduce the negative experiences of directly and explicitly mentioning a group member.

In this way, the system 200 for graph-based modeling of relational affect in group interactions may consider a modulation effect of relational context on human interaction, that alters the perception and experience of relational affect within a group including the two or more individuals by embedding the differences in relational context information at different circumstances or at different stages of interaction within edges of the GNN 234.

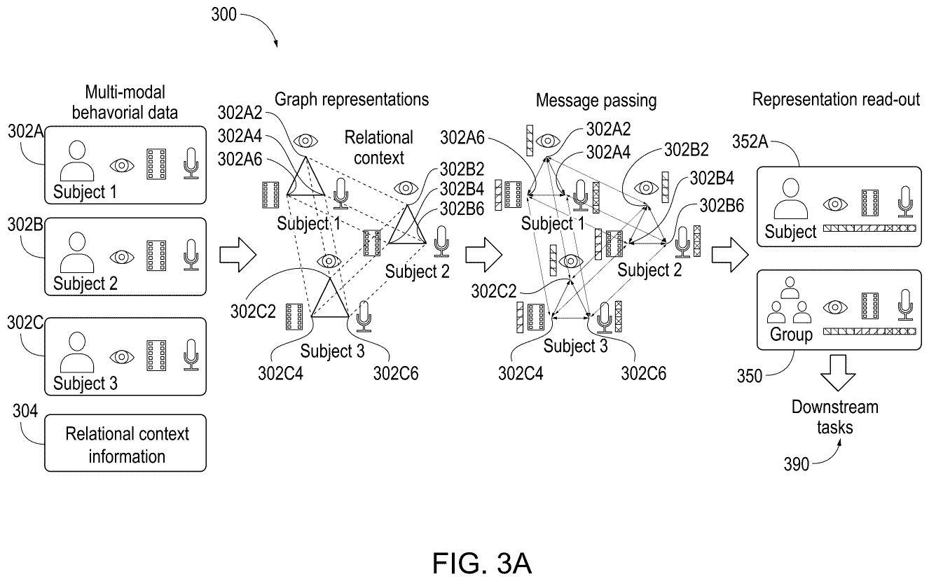

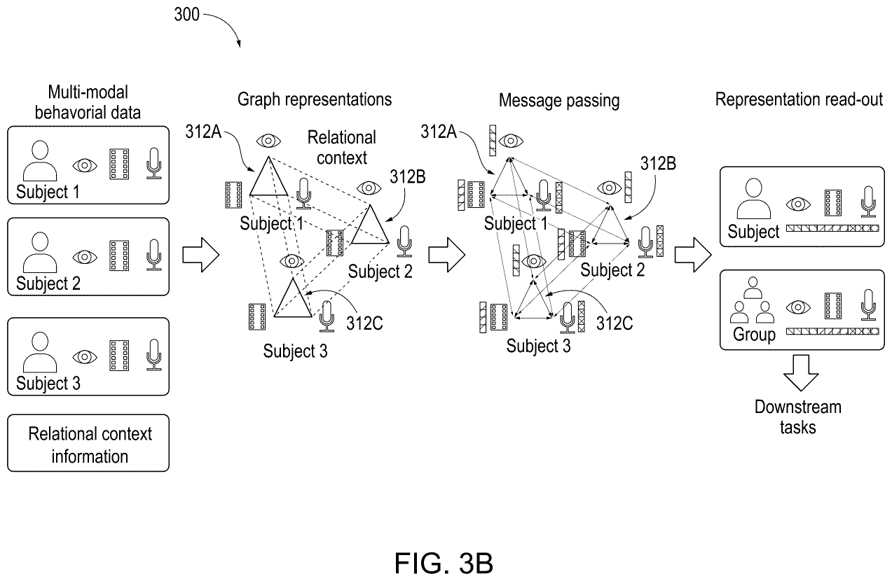

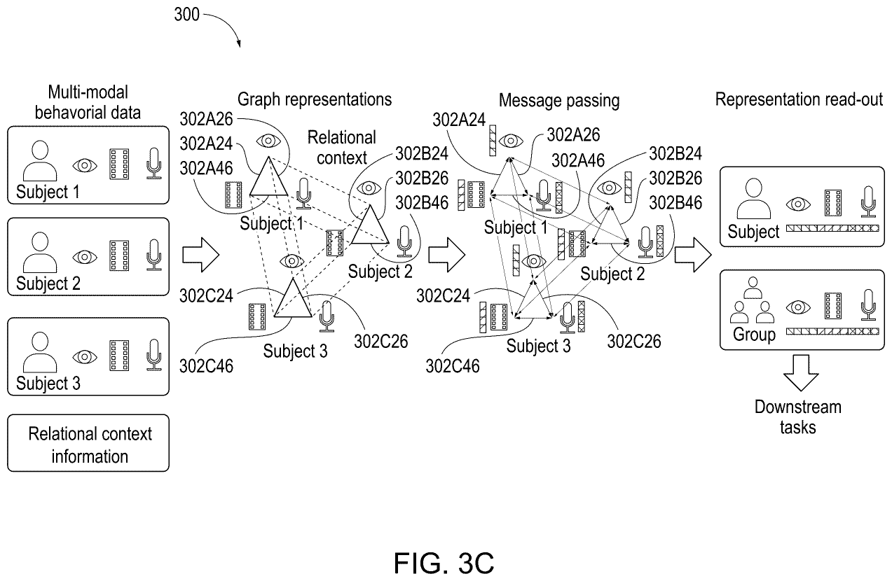

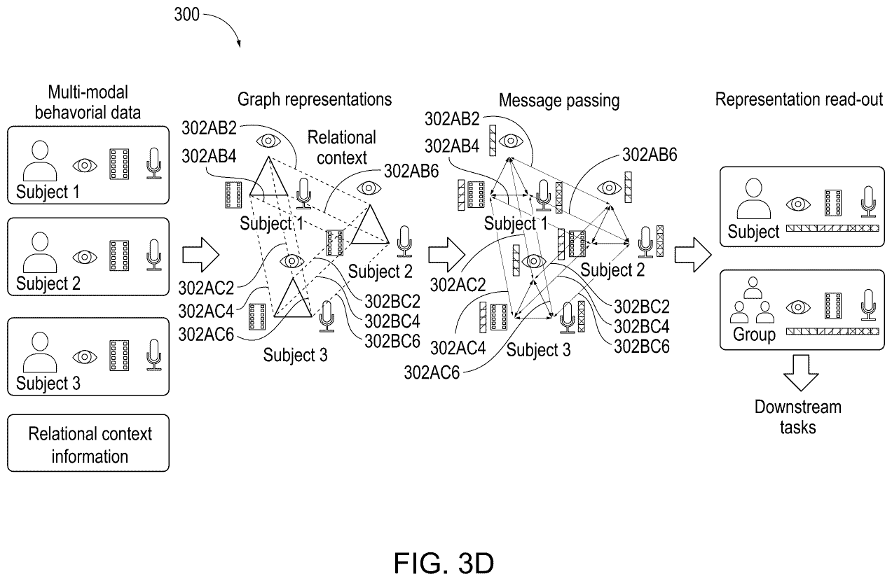

FIG. 3A-3D are exemplary implementations in relation to the computer-implemented method and the system 200 for graph-based modeling 300 of relational affect in group interactions of FIGS. 1-2, according to one aspect. As seen in FIG. 3A, the processor 212 may receive multi-modal behavioral data 302A associated with a first individual of the two or more individuals, multi-modal behavioral data 302B associated with a second individual of the two or more individuals, multi-modal behavioral data 302C associated with a third individual of the two or more individuals, and relational context information 304. The processor 212 may generate the GNN 234 based on the multi-modal behavioral data 302A, 302B, 302C and the relational context information 304. The GNN 234 may include nodes corresponding to the multi-modal behavioral data 302A, 302B, 302C for each of the individuals.

For example, nodes 302A2, 302A4, 302A6 may correspond to eye tracking, image, and audio data associated with the first individual. Nodes 302B2, 302B4, 302B6 may correspond to eye tracking, image, and audio data associated with the second individual. Nodes 302C2, 302C4, 302C6 may correspond to eye tracking, image, and audio data associated with the third individual.

As seen in FIG. 3B-3C, nodes 302A2, 302A4, 302A6, when connected by edges 302A24, 302A26, 302A46, form a first individual-level subgraph 312A associated with a first individual (e.g., 302A). Together, nodes 302B2, 302B4, 302B6, when connected by edges 302B24, 302B26, 302B46, form a second individual-level subgraph 312B associated with a second individual (e.g., 302B). Together, nodes 302C2, 302C4, 302C6, when connected by edges 302C24, 302C26, 302C46, form a third individual-level subgraph 312C associated with a third individual (e.g., 302C). In this way, the GNN is formed to include multiple individual-level subgraphs 312A, 312B, 312C.

As discussed herein, the processor 212 may perform message passing between the nodes of the GNN 234 using individual message passing between a first node 302A2 of the first individual-level subgraph 312A and a second node 302A4 of the first individual-level subgraph 312A. Similarly, individual message passing may be performed between other nodes of the first individual-level subgraph 312A or for other individual-level subgraphs 312B, 312C, for example.

As seen in FIG. 3D, edges 302AB2, 302AC2, 302BC2 may connect corresponding first nodes of individual-level subgraph for different individuals. Edges 302AB4, 302AC4, 302BC4 may connect corresponding second nodes of individual-level subgraph for different individuals. Edges 302AB6, 302AC6, 302BC6 may connect corresponding third nodes of individual-level subgraph for different individuals.

As discussed herein, the processor 212 may perform message passing between the nodes of the GNN 234 using interpersonal message passing. For example, interpersonal message passing may occur between a first node 302A2 of a first individual-level subgraph 312A associated with a first individual 302A and a first node 302B2 of a second individual-level subgraph 312B associated with a second individual 302B via edge 302AB2. Similarly, other interpersonal message passing may be performed between other nodes of individual-level subgraphs 312A, 312B, 312C, for example.

Additionally, the processor 212 may perform message passing over the entire group-level graph to model the group interaction.

Representation read-out may pertain to a single individual (e.g., individual representation read-out 352A associated with the individual from 302A) or a group or sub-group of individuals (e.g., group representation read-out 350 associated with the group of individuals from 302A, 302B, 302C). These representation read-outs may be utilized by the processor to implement downstream tasks or downstream actions 390.

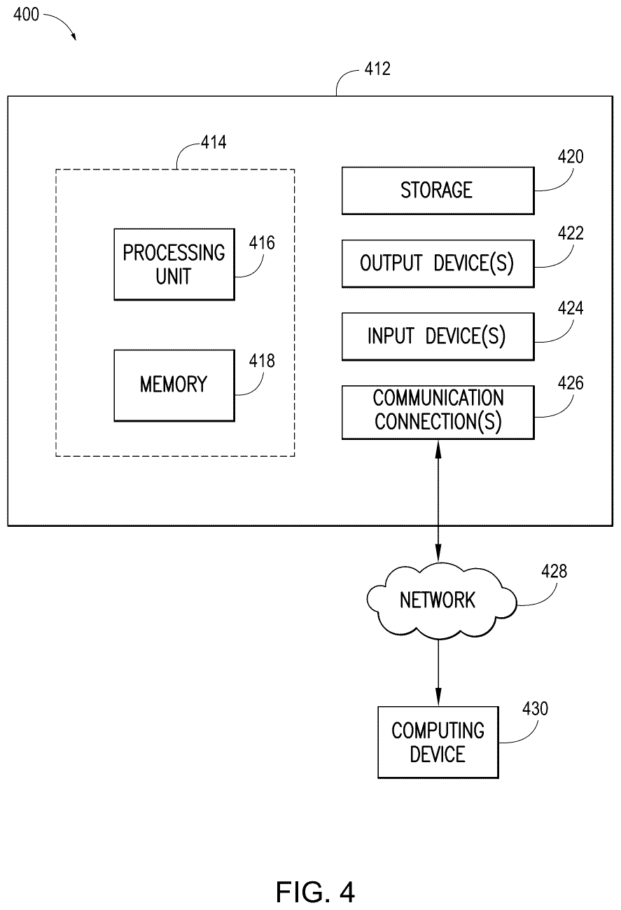

FIG. 4 and the following discussion provide a description of a suitable computing environment to implement aspects of one or more of the provisions set forth herein. The operating environment of FIG. 4 is merely one example of a suitable operating environment and is not intended to suggest any limitation as to the scope of use or functionality of the operating environment. Example computing devices include, but are not limited to, personal computers, server computers, hand-held or laptop devices, mobile devices, such as mobile phones, Personal Digital Assistants (PDAs), media players, and the like, multiprocessor systems, consumer electronics, mini computers, mainframe computers, distributed computing environments that include any of the above systems or devices, etc.

Generally, aspects are described in the general context of “computer readable instructions” being executed by one or more computing devices. Computer readable instructions may be distributed via computer readable media as will be discussed below. Computer readable instructions may be implemented as program modules, such as functions, objects, Application Programming Interfaces (APIs), data structures, and the like, that perform one or more tasks or implement one or more abstract data types. Typically, the functionality of the computer readable instructions are combined or distributed as desired in various environments.

FIG. 4 illustrates a system 400 including a computing device 412 configured to implement one aspect provided herein. In one configuration, the computing device 412 includes at least one processing unit 416 and memory 418. Depending on the exact configuration and type of computing device, memory 418 may be volatile, such as RAM, non-volatile, such as ROM, flash memory, etc., or a combination of the two. This configuration is illustrated in FIG. 4 by dashed line 414.

In other aspects, the computing device 412 includes additional features or functionality. For example, the computing device 412 may include additional storage such as removable storage or non-removable storage, including, but not limited to, magnetic storage, optical storage, etc. Such additional storage is illustrated in FIG. 4 by storage 420. In one aspect, computer readable instructions to implement one aspect provided herein are in storage 420. Storage 420 may store other computer readable instructions to implement an operating system, an application program, etc. Computer readable instructions may be loaded in memory 418 for execution by the at least one processing unit 416, for example.

The term “computer readable media” as used herein includes computer storage media. Computer storage media includes volatile and nonvolatile, removable, and non-removable media implemented in any method or technology for storage of information such as computer readable instructions or other data. Memory 418 and storage 420 are examples of computer storage media. Computer storage media includes, but is not limited to, RAM, ROM, EEPROM, flash memory or other memory technology, CD-ROM, Digital Versatile Disks (DVDs) or other optical storage, magnetic cassettes, magnetic tape, magnetic disk storage or other magnetic storage devices, or any other medium which may be used to store the desired information and which may be accessed by the computing device 412. Any such computer storage media is part of the computing device 412.

The term “computer readable media” includes communication media. Communication media typically embodies computer readable instructions or other data in a “modulated data signal” such as a carrier wave or other transport mechanism and includes any information delivery media. The term “modulated data signal” includes a signal that has one or more of its characteristics set or changed in such a manner as to encode information in the signal.

The computing device 412 includes input device(s) 424 such as keyboard, mouse, pen, voice input device, touch input device, infrared cameras, video input devices, or any other input device. Output device(s) 422 such as one or more displays, speakers, printers, or any other output device may be included with the computing device 412. Input device(s) 424 and output device(s) 422 may be connected to the computing device 412 via a wired connection, wireless connection, or any combination thereof. In one aspect, an input device or an output device from another computing device may be used as input device(s) 424 or output device(s) 422 for the computing device 412. The computing device 412 may include communication connection(s) 426 to facilitate communications with one or more other devices 430, such as through network 428, for example.

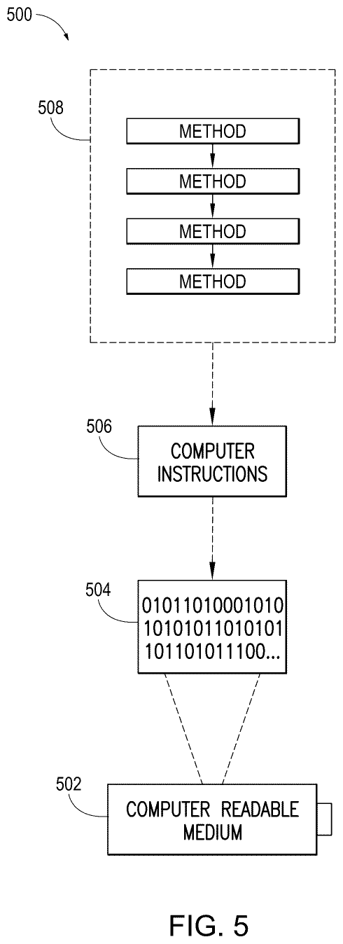

Still another aspect involves a computer-readable medium including processor-executable instructions configured to implement one aspect of the techniques presented herein. An aspect of a computer-readable medium or a computer-readable device devised in these ways is illustrated in FIG. 5, wherein an implementation 500 includes a computer-readable medium 502, such as a CD-R, DVD-R, flash drive, a platter of a hard disk drive, etc., on which is encoded computer-readable data 504. This encoded computer-readable data 504, such as binary data including a plurality of zero's and one's as shown in 504, in turn includes a set of processor-executable computer instructions 506 configured to operate according to one or more of the principles set forth herein. In this implementation 500, the processor-executable computer instructions 506 may be configured to perform a method 508, such as the computer-implemented method 100 for graph-based modeling of relational affect in group interactions of FIG. 1. In another aspect, the processor-executable computer instructions 506 may be configured to implement a system, such as the system 200 for graph-based modeling of relational affect in group interactions of FIG. 2. Many such computer-readable media may be devised by those of ordinary skill in the art that are configured to operate in accordance with the techniques presented herein.

As used in this application, the terms “component”, “module,” “system”, “interface”, and the like are generally intended to refer to a computer-related entity, either hardware, a combination of hardware and software, software, or software in execution. For example, a component may be, but is not limited to being, a process running on a processor, a processing unit, an object, an executable, a thread of execution, a program, or a computer. By way of illustration, both an application running on a controller and the controller may be a component. One or more components residing within a process or thread of execution and a component may be localized on one computer or distributed between two or more computers.

Further, the claimed subject matter is implemented as a method, apparatus, or article of manufacture using standard programming or engineering techniques to produce software, firmware, hardware, or any combination thereof to control a computer to implement the disclosed subject matter. The term “article of manufacture” as used herein is intended to encompass a computer program accessible from any computer-readable device, carrier, or media. Of course, many modifications may be made to this configuration without departing from the scope or spirit of the claimed subject matter.

Although the subject matter has been described in language specific to structural features or methodological acts, it is to be understood that the subject matter of the appended claims is not necessarily limited to the specific features or acts described above. Rather, the specific features and acts described above are disclosed as example aspects.

Various operations of aspects are provided herein. The order in which one or more or all of the operations are described should not be construed as to imply that these operations are necessarily order dependent. Alternative ordering will be appreciated based on this description. Further, not all operations may necessarily be present in each aspect provided herein.

As used in this application, “or” is intended to mean an inclusive “or” rather than an exclusive “or”. Further, an inclusive “or” may include any combination thereof (e.g., A, B, or any combination thereof). In addition, “a” and “an” as used in this application are generally construed to mean “one or more” unless specified otherwise or clear from context to be directed to a singular form. Additionally, at least one of A and B and/or the like generally means A or B or both A and B. Further, to the extent that “includes”, “having”, “has”, “with”, or variants thereof are used in either the detailed description or the claims, such terms are intended to be inclusive in a manner similar to the term “comprising”.

Further, unless specified otherwise, “first”, “second”, or the like are not intended to imply a temporal aspect, a spatial aspect, an ordering, etc. Rather, such terms are merely used as identifiers, names, etc. for features, elements, items, etc. For example, a first channel and a second channel generally correspond to channel A and channel B or two different or two identical channels or the same channel. Additionally, “comprising”, “comprises”, “including”, “includes”, or the like generally means comprising or including, but not limited to.

It will be appreciated that various of the above-disclosed and other features and functions, or alternatives or varieties thereof, may be desirably combined into many other different systems or applications. Also, that various presently unforeseen or unanticipated alternatives, modifications, variations, or improvements therein may be subsequently made by those skilled in the art which are also intended to be encompassed by the following claims.

1. A computer-implemented method for graph-based modeling of relational affect in group interactions, comprising:
generating a graph neural network (GNN) based on multi-modal behavioral data associated with interactions between two or more individuals for each of the two or more individuals and relational context information associated with the interaction or the two or more individuals;
performing message passing between nodes of the GNN based on the relational context information;
generating a representation read-out associated with the GNN or a subgraph of the GNN; and
performing an action based on the representation read-out.

2. The computer-implemented method for graph-based modeling of relational affect in group interactions of claim 1, wherein edges of the GNN are associated with weights based on the relational context information.

3. The computer-implemented method for graph-based modeling of relational affect in group interactions of claim 2, wherein the performing the message passing between the nodes of the GNN is based on the weights associated with the respective edges.

4. The computer-implemented method for graph-based modeling of relational affect in group interactions of claim 1, wherein the multi-modal behavioral data includes eye-tracking data, image data, video data, or audio data.

5. The computer-implemented method for graph-based modeling of relational affect in group interactions of claim 1, wherein the relational context information includes a native language associated with an individual of the two or more individuals, an educational level associated with the individual, a position of the individual, or a background of the individual.

6. The computer-implemented method for graph-based modeling of relational affect in group interactions of claim 1, wherein the performing the message passing between the nodes of the GNN includes individual message passing between:
a first node of a first individual-level subgraph associated with a first individual of the two or more individuals; and
a second node of the first individual-level subgraph.

7. The computer-implemented method for graph-based modeling of relational affect in group interactions of claim 1, wherein the performing the message passing between the nodes of the GNN includes interpersonal message passing between:
a first node of a first individual-level subgraph associated with a first individual of the two or more individuals; and
a first node of a second individual-level subgraph associated with a second individual of the two or more individuals.

8. The computer-implemented method for graph-based modeling of relational affect in group interactions of claim 1, wherein the representation read-out associated with the GNN is a representation read-out indicative of relational affect associated with the two or more individuals.

9. The computer-implemented method for graph-based modeling of relational affect in group interactions of claim 1, wherein the representation read-out associated with the subgraph of the GNN is a representation read-out indicative of relational affect associated with one or more of the two or more individuals.

10. The computer-implemented method for graph-based modeling of relational affect in group interactions of claim 1, wherein the action is:
a social mediation action implemented by a robot;
a social networking action implemented by a processor; or a reformulation of the GNN.

11. A system for graph-based modeling of relational affect in group interactions, comprising:
a memory storing one or more instructions; and
a processor executing one or more of the instructions stored on the memory to perform:
generating a graph neural network (GNN) based on multi-modal behavioral data associated with interactions between two or more individuals for each of the two or more individuals and relational context information associated with the interaction or the two or more individuals, wherein edges of the GNN are associated with weights based on the relational context information;
performing message passing between nodes of the GNN based on the weights of respective edges; and
generating a representation read-out associated with the GNN or a subgraph of the GNN.

12. The system for graph-based modeling of relational affect in group interactions of claim 11, wherein the multi-modal behavioral data includes eye-tracking data, image data, video data, or audio data.

13. The system for graph-based modeling of relational affect in group interactions of claim 11, wherein the relational context information includes a native language associated with an individual of the two or more individuals, an educational level associated with the individual, a position of the individual, or a background of the individual.

14. The system for graph-based modeling of relational affect in group interactions of claim 11, wherein the processor performs the message passing between the nodes of the GNN includes individual message passing between:
a first node of a first individual-level subgraph associated with a first individual of the two or more individuals; and
a second node of the first individual-level subgraph.

15. The system for graph-based modeling of relational affect in group interactions of claim 11, wherein the processor performs the message passing between the nodes of the GNN includes interpersonal message passing between:
a first node of a first individual-level subgraph associated with a first individual of the two or more individuals; and
a first node of a second individual-level subgraph associated with a second individual of the two or more individuals.

16. A robot for mediating group interactions based on graph-based modeling of relational affect of the group interactions, comprising:
a memory storing one or more instructions;
a processor executing one or more of the instructions stored on the memory to perform:
generating a graph neural network (GNN) based on multi-modal behavioral data associated with interactions between two or more individuals for each of the two or more individuals and relational context information associated with the interaction or the two or more individuals, wherein edges of the GNN are associated with weights based on the relational context information;
performing message passing between nodes of the GNN based on the weights of respective edges; and
generating a representation read-out associated with the GNN or a subgraph of the GNN;
an output device performing a social mediation action based on the representation read-out.

17. The robot for mediating group interactions based on graph-based modeling of relational affect of the group interactions of claim 16, wherein the multi-modal behavioral data includes eye-tracking data, image data, video data, or audio data.

18. The robot for mediating group interactions based on graph-based modeling of relational affect of the group interactions of claim 16, wherein the relational context information includes a native language associated with an individual of the two or more individuals, an educational level associated with the individual, a position of the individual, or a background of the individual.

19. The robot for mediating group interactions based on graph-based modeling of relational affect of the group interactions of claim 16, wherein the performing the message passing between the nodes of the GNN includes individual message passing between:
a first node of a first individual-level subgraph associated with a first individual of the two or more individuals; and
a second node of the first individual-level subgraph.

20. The robot for mediating group interactions based on graph-based modeling of relational affect of the group interactions of claim 16, wherein the performing the message passing between the nodes of the GNN includes interpersonal message passing between:
a first node of a first individual-level subgraph associated with a first individual of the two or more individuals; and
a first node of a second individual-level subgraph associated with a second individual of the two or more individuals.
